(19) United States
(12) Patent Application Publication
(10) Pub. No.: US 2025/0311673 A1
(43) Pub. Date: Oct. 9, 2025

(54) AGRICULTURAL VEHICLE WITH HEADER HAVING A TRACKING WHEEL SYSTEM WITH A ROTATION-INDUCING PROJECTION

(71) Applicant: CNH Industrial Belgium N.V., Zedelgem (BE)

(72) Inventors: Jovanni Wyseur, Zedelgem (BE); Simon Beelaert, Adegem (BE); Stijn Van Belleghem, Maldegem (BE); Jeffrey Blancke, Markegem (BE)

(73) Assignee: CNH Industrial Belgium N.V., Zedelgem (BE)

(21) Appl. No.: 18/869,339

(22) PCT Filed: May 27, 2023
(86) PCT No.: PCT/EP2023/064301

§ 371 Date: Nov. 26, 2024

(30) Foreign Application Priority Data
May 30, 2022 (EP) 22176221

(51) Int. Cl. A01D 41/14; A01B 73/00

(52) U.S. Cl. CPC A01D 41/14; A01B 73/00

(57) ABSTRACT

A header for an agricultural vehicle includes: a header frame; a windguard assembly carried by the header frame, the windguard assembly including a windguard roller coupled to a windguard arm that is pivotably coupled to the header frame; and a tracking wheel assembly carried by the header frame and including a tracking wheel coupled to a tracking fork. The tracking fork is pivotable from a first position to a second position and includes a projection that contacts the windguard arm as the tracking fork pivots from the first position to the second position such that contact of the projection with the windguard arm causes the tracking wheel to rotate to an orientation where the tracking fork abuts against the windguard arm to inhibit rotation of the tracking wheel when the tracking fork is in the second position.

### BACKGROUND OF THE INVENTION

The present invention relates to agricultural vehicles and, more particularly, to tracking wheel assemblies for agricultural vehicles.

Certain agricultural machines, such as forage harvesters and balers, are required to collect crop material, that has been cut, from the field. The component of such agricultural machines which gathers the crop material and feeds it further into the machine for processing is generally known as a pick-up assembly. A pick-up assembly typically comprises a pickup drum rotatably mounted on a frame, with radially arranged projecting tines to collect the crop material and propel it upwards, past a guiding element and then into a feed channel through which the crop material is conveyed into the machine for subsequent processing, such as baling, threshing, chopping, storing and/or depositing. This guiding element is generally referred to as a windguard, and serves the purposes of restricting the movement of the collected crop material in the forward and upward direction, shielding the crop flow path from wind influence and guiding the crop material efficiently into the feed channel.

Known headers may include tracking wheels that run on a ground surface to support the tines at a certain height from the ground. The tracking wheels generally travel in the same direction as the header when the header is operating so the tracking wheels roll in the travel direction of the header during operation. When the header is being transported on a public road, the header must meet certain size requirements. One such requirement is the width of the header, which may not be satisfied if the tracking wheels stay in their operating position on lateral sides of the header.

What is needed in the art is a way to move tracking wheels of a header to a transport position that addresses some of the issues associated with known headers.

### SUMMARY OF THE INVENTION

The present invention provides a header with a windguard roller coupled to a windguard arm and a tracking wheel coupled to a pivotable tracking fork that includes a projection that contacts the windguard arm as the tracking fork pivots from a first position to a second position in order to rotate the tracking wheel so the tracking fork abuts against the windguard arm to inhibit rotation of the tracking wheel.

In some exemplary embodiments disclosed herein, a header for an agricultural vehicle includes: a header frame; a windguard assembly carried by the frame, the windguard assembly including a windguard roller coupled to a windguard arm that is pivotably coupled to the header frame; and a tracking wheel assembly carried by the header frame and including a tracking wheel coupled to a tracking fork. The tracking fork is pivotable from a first position to a second position and includes a projection that contacts the windguard arm as the tracking fork pivots from the first position to the second position such that contact of the projection with the windguard arm causes the tracking wheel to rotate to an orientation where the tracking fork abuts against the windguard arm to inhibit rotation of the tracking wheel when the tracking fork is in the second position.

In some embodiments, the tracking fork carries the tracking wheel as the tracking fork pivots from the first position to the second position.

In some embodiments, the tracking wheel is rotatable independently of pivoting of the tracking fork.

In some embodiments, the tracking fork is coupled to a tracking arm that is pivotably coupled to the header frame. In some embodiments, the tracking arm includes a pivot opening and the tracking fork includes a pivot stem held in the pivot opening, the pivot stem defining an axis of rotation of the tracking wheel.

In some embodiments, the projection slides across the windguard arm as the tracking fork pivots from the first position to the second position and the projection sliding across the windguard arm causes the tracking wheel to rotate.

In some embodiments, the tracking fork pivots through a pivot path from the first position to the second position and the projection contacts the windguard arm during a portion of the tracking fork pivoting through the pivot path.

In some embodiments, the projection comprises a rounded surface that contacts the windguard arm to cause the tracking wheel to rotate. In some embodiments, the projection includes a hoop extending from the tracking fork, the hoop preferably defining a semi-circular shape.

In some embodiments, a wheel axis of the tracking wheel is generally parallel, preferably completely parallel, with a rotation axis of the windguard roller when the tracking fork is in the second position.

In some embodiments, the tracking wheel includes an axle defining the wheel axis and the tracking fork includes a pair of fork prongs that each couple to the axle, with one of the fork prongs preferably abutting against the windguard arm when the tracking fork is in the second position to inhibit rotation of the tracking wheel. In some embodiments, the projection couples the fork prongs together.

In some embodiments, the windguard arm includes a contact section that the projection contacts as the tracking fork pivots to the second position, the contact section includes a side portion of the windguard arm.

In some exemplary embodiments disclosed herein, an agricultural vehicle includes a chassis, the previously described header carried by the chassis, and a pickup including a plurality of tines. In some embodiments, the agricultural vehicle is in the form of a forage harvester.

A possible advantage that may be realized by exemplary embodiments provided according to the present disclosure is that the projection contacting the windguard arm and causing the tracking wheel to rotate to the proper orientation as the tracking fork pivots provides a reliable way of orienting the tracking wheel for transport.

Another possible advantage that may be realized by exemplary embodiments provided according to the present disclosure is that rotation of the tracking wheel can be inhibited when the tracking fork pivots to the second position by the tracking fork pressing against the windguard arm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an exemplary embodiment of an agricultural vehicle including a header, illustrated in the form of a forage harvester, provided according to the present disclosure;

FIG. 2 is a perspective view of the agricultural vehicle of FIG. 1 with a tracking fork in a first position and a tracking wheel in a first orientation, in accordance with the present disclosure;

FIG. 3 is a perspective view of the agricultural vehicle of FIGS. 1-2 as the tracking fork is pivoting towards a second position with a projection of the tracking fork contacting a windguard arm;

FIG. 4 is a front view of the tracking fork in the position illustrated in FIG. 3;

FIG. 5 is a top view of the tracking fork in the position illustrated in FIGS. 3-4; and

FIG. 6 is a top view of the tracking fork in the second position with the tracking wheel in a second orientation so the tracking fork abuts against the windguard arm to inhibit rotation of the tracking wheel and a wheel axis of the tracking wheel is generally parallel with a rotation axis of a windguard roller.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

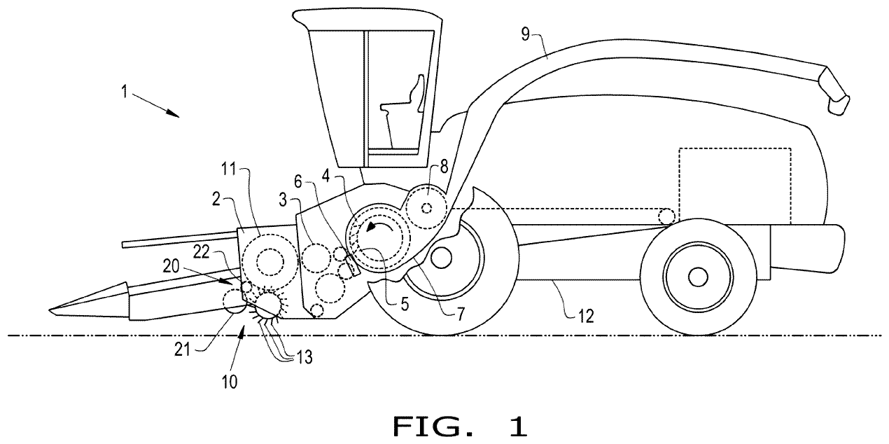

FIG. 1 shows a schematic side view of an exemplary embodiment of an agricultural vehicle, illustrated in the form of a forage harvester 1. As the harvester 1 advances through a field, crops are gathered by a header 2 and transported to a central area of the header 2 where the crops enter a set of feed rolls 3. The rolls 3 guide the crops in the form of a mat with a given thickness towards the cutting drum 4, which rotates in the direction indicated by the arrow, about a rotation axis that is transversal to the direction of movement of the crops. Knives 5 are mounted on the drum 4 (only four are shown, the knives 5 are distributed along the full circumference of the drum 4), so that the knives 5 pass by a stationary shear bar 6 as the drum 4 rotates, thereby chopping the crops into small pieces which are further transported between the cutting drum 4 and a concave 7. The chopped material is then ejected by a blower 8 through a spout 9. The harvester 1 includes a pickup 10 that picks up crop material and moves it toward a crop material conveyor 11, illustrated in the form of an auger. The harvester 1 also includes a chassis 12, which carries the components of the harvester 1. The pickup 10 includes a plurality of rotatable tines 13 that are configured to pickup crop material as the forage harvester 1 travels forward. To reduce the risk of wind blowing away crop material, the header 2 also includes a windguard assembly 20 that includes at least one windguard roller, illustrated as a first windguard roller 21 and a second windguard roller 22. It should be appreciated that while the agricultural vehicle 1 is illustrated and described as a forage harvester, in some embodiments the agricultural vehicle is in the form of other agricultural vehicles such as a combine harvester, e.g., a harvester configured for harvesting wheat, corn, or other grains, or a baler, e.g., a large square baler, a small square baler, or a round baler.

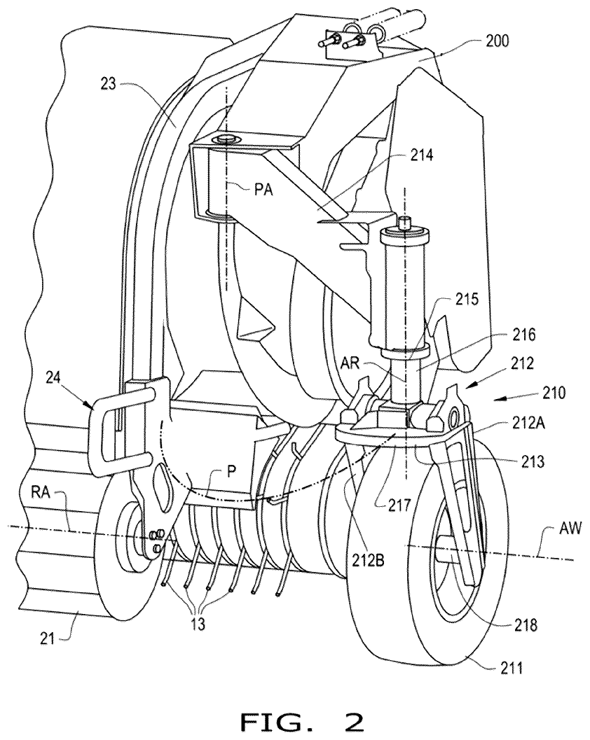

Referring now to FIG. 2, it is illustrated that the windguard assembly 20 includes a windguard arm 23 that is pivotably coupled to a header frame 200 of the header 2. The header frame 200 may also carry the pickup 10. The windguard arm 23 is coupled to the first windguard roller 21 so the first windguard roller 21 is pivotable while the second windguard roller 22 may be a stationary roller. It should be appreciated that while only one windguard arm 23 is illustrated coupled to the first windguard roller 21 in FIG. 2, another similar windguard arm 23 may be coupled to an opposite end of the first windguard roller 21 so both ends of the first windguard roller 21 are supported by a respective windguard arm.

The header 2 also includes a tracking wheel assembly 210. The tracking wheel assembly 210 includes a tracking wheel 211 that is coupled to a tracking fork 212. As illustrated in FIG. 2, the tracking wheel 211 may be provided in a first orientation, which may also be referred to herein as an “operating orientation,” that is parallel to a travel direction of the header 2 when the header 2 is operating in a field. The tracking wheel 211 may help keep the tines 13 at a desired height, relative to the ground, during operation.

In known agricultural vehicles, the tracking wheels generally run in an operating position and orientation at the side of the header next to the tines close to the center of a reel carrying the tines in order to provide optimal ground following of the tines in changing ground conditions and levels. The wheels are also run at a certain width so the wheels can rotate while making a turn of changing from the driving direction without hitting the header. These requirements make it so the tracking wheels cannot be driven on public roads in the operating position and orientation and must be moved. However, it has been found that the width of the windguard assembly limits the available space for the tracking wheels and the wheels may be prone to rotating if not locked into place, which can cause the wheels to hit the windguard roller and/or move outside the legally allowed road width.

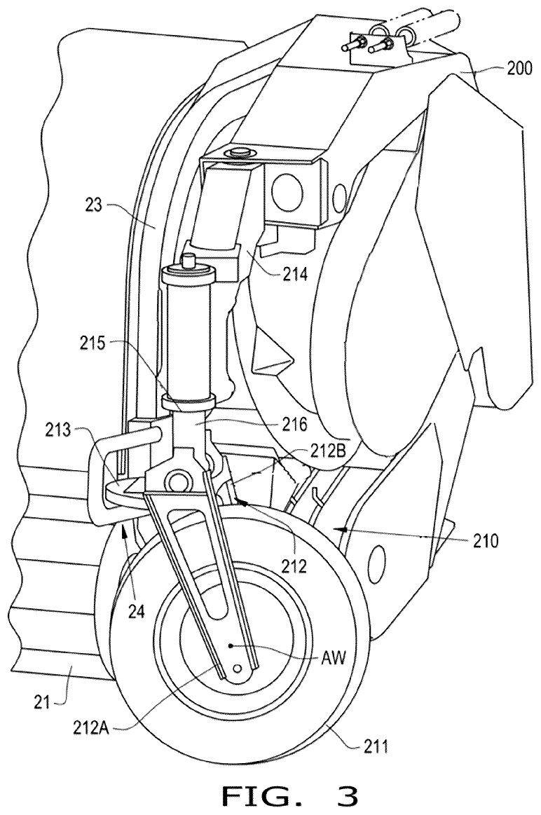

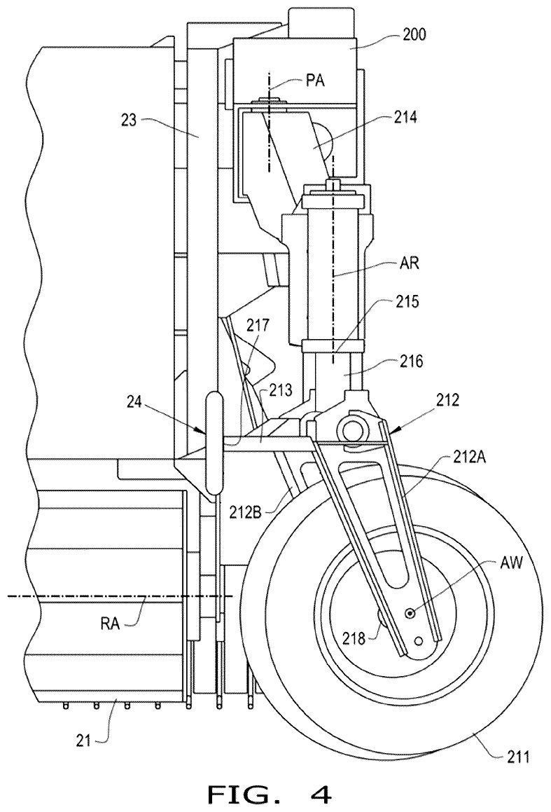

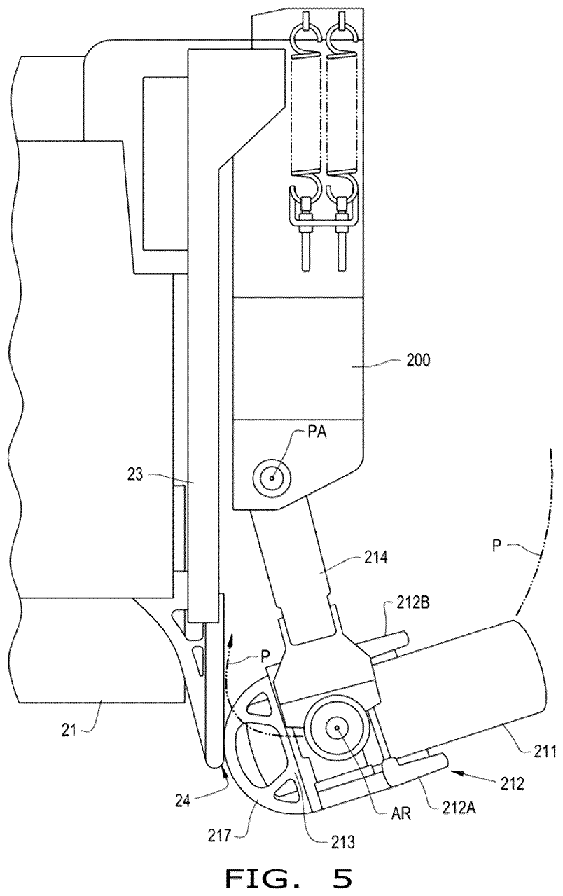

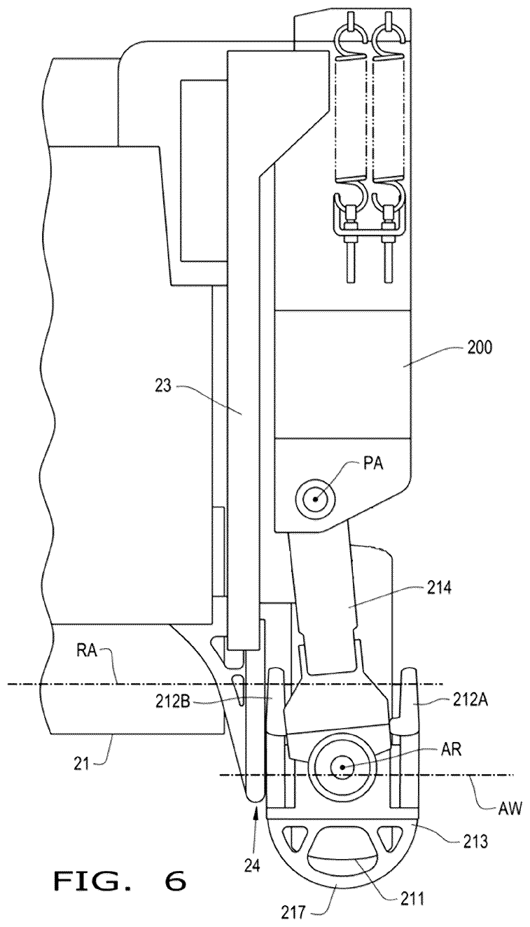

To address some of the previously described issues, and referring still to FIG. 2 and now FIGS. 3-6 as well, the tracking fork 212 is pivotable from a first position, illustrated in FIG. 2, to a second position, illustrated in FIG. 6, and includes a projection 213 that contacts the windguard arm 23 as the tracking fork 212 pivots from the first position to the second position. The projection 213 may be any portion of the tracking fork 212 that contacts the windguard arm 23 during pivoting of the tracking fork 212 from the first position to the second position. The contact of the projection 213 with the windguard arm 23 causes the tracking wheel 211 to rotate to an orientation where the tracking fork 212 abuts against the windguard arm 23 (best illustrated in FIG. 6) to inhibit rotation of the tracking wheel 211 when the tracking fork 212 is in the second position. The projection 213 contacting the windguard arm 23 as the tracking fork 212 pivots to rotate the tracking wheel 211 so the tracking fork 212 abuts against the windguard arm 23 to inhibit rotation of the tracking wheel 211 provides a reliable and convenient way to rotate the tracking wheel 211 to the desired orientation and lock the tracking wheel 211 for road transport without needing, for example, to effect a separate movement of the tracking wheel 211 either manually by a user or using a separate element, such as an actuator.

In some embodiments, a wheel axis AW of the tracking wheel 211 is generally parallel with a rotation axis RA of the first windguard roller 21 when the tracking fork 212 is in the second position. The wheel axis AW of the tracking wheel 211 is the axis about which the tracking wheel 211 rotates when rolling across a surface. As used herein, the tracking wheel 211 is “generally parallel” when the wheel axis AW of the tracking wheel 211 extends at an angle of no more than 10° relative to the rotation axis RA. Preferably, the wheel axis AW of tracking wheel 211 is completely parallel to the rotation axis RA of the first windguard roller 21 so no angle is defined between the wheel axis AW of the tracking wheel 211 and the rotation axis RA when the tracking fork 212 is in the second position. It should be appreciated that, according to the present disclosure, the wheel axis AW of the tracking wheel 211 is also considered to be “completely parallel” to the rotation axis RA of the first windguard roller 21 when the wheel axis AW is co-axial with the rotation axis RA. In some embodiments, the tracking wheel 211 is oriented so the wheel axis AW is parallel to the rotation axis RA in the first position of the tracking fork 212 as well.

In some embodiments, the tracking fork 212 carries the tracking wheel 211 as the tracking fork 212 pivots from the first position to the second position. The tracking fork 212 may, for example, include a pair of fork prongs 212A, 212B that each couple to an axle 218 defining the wheel axis AW of the tracking wheel 211. By having the tracking fork 212 carry the tracking wheel 211 while pivoting from the first position to the second position and simultaneously causing rotation of the tracking wheel 211, the tracking wheel 211 can be moved to both a desired position and orientation via the pivoting of the tracking fork 212. It should be appreciated that, in some embodiments, the tracking fork 212 may be configured to pivot from a first position to a second position without causing further pivoting, or any pivoting at all, of the tracking wheel 211 while still causing rotation of the tracking wheel 211. It should thus be appreciated that the tracking fork 212 does not necessarily need to cause pivoting of the tracking wheel 211 in order to rotate the tracking wheel 211. In this respect, the tracking wheel 211 may be rotatable independently of pivoting of the tracking fork 212. Further, as can be appreciated from comparing FIGS. 2 and 6, pivoting the tracking fork 212 from the first position to the second position can bring the tracking wheel 211 laterally inward to reduce the overall width of the header 2 relative to when the tracking fork 212 is in the first position while still locking the tracking wheel 211 against rotation in an orientation where the wheel axis AW is parallel to the rotation axis RA for road transport.

To rotate the tracking wheel 211 independently of pivoting of the tracking fork 212, the tracking fork 212 may be coupled to a tracking arm 214 that is pivotably coupled to the header frame 200. Pivoting of the tracking arm 214 about a pivot axis PA causes a corresponding pivoting of the tracking fork 212, as can be appreciated from comparing FIG. 2 with FIGS. 3-6. The tracking arm 214 may include a pivot opening 215 and the tracking fork 212 may include a pivot stem 216 that is held in the pivot opening 215. The pivot stem 216 may be rotatable within the pivot opening 215 about an axis that also defines an axis of rotation AR of the tracking wheel 211 such that rotation of the pivot stem 216 within the pivot opening 215 causes a corresponding rotation of the tracking wheel 211 about the axis of rotation AR. The pivot stem 216 being held in the pivot opening 215 also allows pivoting of the tracking arm 214 to cause pivoting of the tracking fork 212 about the pivot axis PA, due to contact between sidewalls of the pivot opening 215 and the pivot stem 216, without rotating the tracking wheel 211 about the axis of rotation AR.

The projection 213 contacts the windguard arm 23 to rotate the tracking wheel 211 as the tracking fork 212 pivots from the first position to the second position. The tracking fork 212 may pivot through a pivot path, indicated by arrow P, from the first position to the second position, which can be appreciated from FIGS. 2-6, with the projection 213 contacting the windguard arm 23 during a portion, i.e., not an entirety, of the tracking fork 212 pivoting through the pivot path P. In some embodiments, the projection 213 slides across the windguard arm 23 as the tracking fork 212 pivots from the first position to the second position, with the projection 213 sliding across the windguard arm 23 causing the tracking wheel 211 to rotate. The shape of the projection 213 is chosen so that the contact, e.g., sliding along, of the projection 213 with the windguard arm 23 causes the desired rotation of the tracking wheel 211 to an orientation where the tracking fork 212 abuts against the windguard arm 23 to inhibit rotation of the tracking wheel 211 and, in some embodiments, so the wheel axis AW is parallel with the rotation axis RA of the first windguard roller 21. The projection 213 may, for example, include a rounded surface 217 that contacts the windguard arm 23, such as by sliding across the windguard arm 23, to cause the tracking wheel 211 to rotate.

As can be appreciated from FIGS. 3-6, the rounded surface 217 sliding across the windguard arm 23 causes a gradual rotation of the tracking wheel 211 as the rounded surface 217 slides across the windguard arm 23. In such embodiments, the projection 213 may comprise a hoop that extends from the tracking fork 212. Preferably, the projection 213 is a hoop defining a semi-circular shape, as illustrated. The projection (hoop) 213 may couple the fork prongs 212A, 212B of the tracking fork 212 to one another and thus act as a support hoop. The projection 213 may extend from any portion of the tracking fork 212 that allows the projection 213 to contact the windguard arm 23 during pivoting of the tracking fork 212 along the pivot path P, e.g., on a front of the tracking fork 212. As especially illustrated in FIGS. 3-5, the windguard arm 23 may include a contact section 24 that the projection 213 contacts as the tracking fork 212 pivots to the second position. The contact section 24 may, for example, include a side portion of the windguard arm 23. When the tracking fork 212 is in the second position, the tracking fork 212, such as a side of one of the fork prongs 212B, is forced to abut against the windguard arm 23, as illustrated in FIG. 6, to inhibit rotation of the tracking wheel 211 in either direction to, for example, prevent the tracking wheel 211 from uncontrollably rotating so the wheel axis AW comes out of being parallel with the rotation axis RA of the first windguard roller 21. The tracking wheel 211 may only be free to rotate again upon the tracking fork 212 being pivoted from the second position back towards the first position so the tracking fork 212 does not abut against the windguard arm 23. Pivoting the tracking fork 212 to the second position thus not only moves the tracking wheel 211 to the proper orientation and position for transport, but also locks the tracking wheel 211 against rotation during transport that may arise due to, for example, bumps on the road during transport. While the projection 213 is described and illustrated as sliding across the windguard arm 23 to cause rotation of the tracking wheel 211, it should be appreciated that the projection 213 does not need to appreciably slide along the windguard arm 23 to rotate the tracking wheel 211 so the tracking fork 212 locks the tracking wheel 211 from rotation, and in some embodiments so the wheel axis AW is parallel with the rotation axis RA of the first windguard roller 21. The projection 213 may momentarily contact the windguard arm 23, for example, so a portion of the windguard arm 23 acts as a strike plate that causes a sudden rotation of the tracking wheel 211 to an orientation where the tracking fork 212 abuts against the windguard arm 23 to inhibit rotation of the tracking wheel 211. It should thus be appreciated that the projection 213 of the tracking fork 212 can be configured in a variety of ways to contact the windguard arm 23 and rotate the tracking wheel 211.

From the foregoing, it should be appreciated that the tracking wheel assembly 210 provided according to the present disclosure provides a tracking fork 212 that pivots to contact the windguard arm 23 and cause rotation of a tracking wheel 211 so the tracking fork 212 abuts against the windguard arm 23 in a manner that inhibits rotation of the tracking wheel 211. The tracking fork 212 may also carry the tracking wheel 211 during pivoting, with rotation of the tracking wheel 211 being independent of the pivoting, so the tracking fork 212 both carries the tracking wheel 211 to the proper position and rotates the tracking wheel 211 to the proper orientation for road transport. The tracking fork 212 can also be pivoted to a position where the wheel axis AW of the tracking wheel 211 is parallel with the rotation axis RA of the first windguard roller 21 when the tracking fork 212 is in the second position so the tracking wheel 211 is oriented for road transport. Thus, the tracking wheel assembly 210 provided according to the present disclosure provides a reliable and convenient way to re-position and lock the tracking wheel 211 for transport that only requires movement of the tracking fork 212, which simplifies the procedure.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-15. (canceled)

16. A header for an agricultural vehicle, said header comprising:
a header frame;
a windguard assembly carried by the header frame, the windguard assembly comprising a windguard roller coupled to a windguard arm that is pivotably coupled to the header frame; and
a tracking wheel assembly carried by the header frame, said tracking wheel assembly comprising a tracking wheel coupled to a tracking fork,
wherein the tracking fork is pivotable from a first position to a second position and the tracking fork comprises a projection that contacts the windguard arm as the tracking fork pivots from the first position to the second position such that contact of the projection with the windguard arm causes the tracking wheel to rotate to an orientation where the tracking fork abuts against the windguard arm to inhibit rotation of the tracking wheel when the tracking fork is in the second position.

17. The header of claim 16, wherein the tracking fork carries the tracking wheel as the tracking fork pivots from the first position to the second position.

18. The header of claim 16, wherein the tracking wheel is rotatable independently of pivoting of the tracking fork.

19. The header of claim 16, wherein the tracking fork is coupled to a tracking arm that is pivotably coupled to the header frame.

20. The header of claim 19, wherein the tracking arm comprises a pivot opening and the tracking fork comprising a pivot stem held in the pivot opening, the pivot stem defining an axis of rotation of the tracking wheel.

21. The header of claim 16, wherein the projection slides across the windguard arm as the tracking fork pivots from the first position to the second position and the projection sliding across the windguard arm causes the tracking wheel to rotate.

22. The header of claim 16, wherein the tracking fork pivots through a pivot path from the first position to the second position and the projection contacts the windguard arm during a portion of the tracking fork pivoting through the pivot path.

23. The header of claim 16, wherein the projection comprises a rounded surface that contacts the windguard arm to cause the tracking wheel to rotate.

24. The header of claim 23, wherein the projection comprises a hoop extending from the tracking fork, the hoop defining a semi-circular shape.

25. The header of claim 16, wherein a wheel axis of the tracking wheel is substantially parallel with a rotation axis of the windguard roller when the tracking fork is in the second position.

26. The header of claim 25, wherein the tracking wheel comprises an axle defining the wheel axis and the tracking fork comprises a pair of fork prongs that each couple to the axle, wherein one of the fork prongs abuts against the windguard arm when the tracking fork is in the second position to inhibit rotation of the tracking wheel.

27. The header of claim 26, wherein the projection couples the fork prongs together.

28. The header of claim 16, wherein the windguard arm comprises a contact section that the projection contacts as the tracking fork pivots to the second position, the contact section comprising a side portion of the windguard arm.

29. An agricultural vehicle, comprising a chassis and the header of claim 16 carried by the chassis and further comprising a pickup comprising a plurality of rotatable tines.

30. The agricultural vehicle of claim 29, wherein the agricultural vehicle is a forage harvester.
